(19) United States
(12) Patent Application Publication
(10) Pub. No.: US 2007/0199072 A1
(43) Pub. Date: Aug. 23, 2007

(54) CONTROL OF APPLICATION ACCESS TO SYSTEM RESOURCES

(75) Inventor: David W. Plummer, Redmond, WA (US)

Correspondence Address: BLACK LOWE & GRAHAM, PLLC, 701 FIFTH AVENUE, SUITE 4800, SEATTLE, WA, 98104, US

(73) Assignee: SoftwareOnline, LLC, Redmond, WA (US)

(21) Appl. No.: 11/549,804

(22) Filed: Oct. 16, 2006

Related U.S. Application Data
(60) Provisional application No. 60/727,288, filed on Oct. 14, 2005.
(60) Provisional application No. 60/805,683, filed on Jun. 23, 2006.

(51) Int. Cl. H04N 7/16

(52) U.S. Cl. 726/26

(57) ABSTRACT

A method executable in a system having a security mechanism that determines access by an application to system resources based on a security context in which the application is run includes receiving definitions of a plurality of security contexts. Each security context provides access to a respective set of the system resources. An association of each application of a plurality of applications with a respective one of the security contexts is received from the user. A first one of the applications is run subject to a first associated security context.

### PRIORITY CLAIM

The present application claims priority from U.S. Provisional Application No. 60/727,288 filed Oct. 14, 2005, which is, along with commonly owned and co-pending U.S. application Ser. No. 11/351,257 filed on Feb. 6, 2006, U.S. patent application Ser. No. ______ (Attorney Ref. No. SFON-1-1005) entitled “Enhanced Browser Security,” U.S. patent application Ser. No. 11/5749,783 (Attorney Ref. No. SFON-1-1007) entitled “Control of Application Access to System Resources,” and U.S. Provisional Application No. 60/805,683 filed on Jun. 23, 2006, herein incorporated by reference in its entirety.

### FIELD OF THE INVENTION

Embodiments of the invention relate generally to computer systems and, more particularly, to improvements in security for computer systems.

### BACKGROUND OF THE INVENTION

In computing, if a task is performed by a user having more privileges than necessary to do that task, there is an increased risk that the user will inadvertently (or perhaps intentionally) do harm to computer resources. By way of example, if a set of files can only be deleted by a user with administrator privileges, then an administrator may inadvertently delete those files when performing another task that does not need to be accomplished by an administrator. If the administrator had been a user having lesser privileges, then the intended task could still have been performed but the inadvertent deletion would not have been allowed.

As such, a goal in computer security is the concept of least privilege in which a user performing a task should run with the absolute minimum privileges (or identities, such as group memberships) necessary to perform that task. At least one operating system permits users to exercise one of two possible choices. First, a user may elect to run the selected application as an administrator, and to execute all programs with administrative privileges. Secondly, the user may elect to run the selected application as a non-administrator, and risk having many programs fail to work as expected.

### SUMMARY OF THE INVENTION

In an embodiment of the invention, a method executable in a system having a security mechanism that determines access by an application to system resources based on a security context in which the application is run includes receiving definitions of a plurality of security contexts. Each security context provides access to a respective set of the system resources. An association of each application of a plurality of applications with a respective one of the security contexts is received from the user. A first one of the applications is run subject to a first associated security context.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a schematic illustration of a user interface according to an embodiment of the invention;

FIG. 4 is a schematic illustration of a user interface according to an embodiment of the invention;

FIG. 5 is a schematic illustration of a user interface according to an embodiment of the invention; and

FIGS. 6-8 are flow diagrams illustrating methods according to embodiments of the invention.

### DETAILED DESCRIPTION OF THE PREFERRED EMBODIMENT

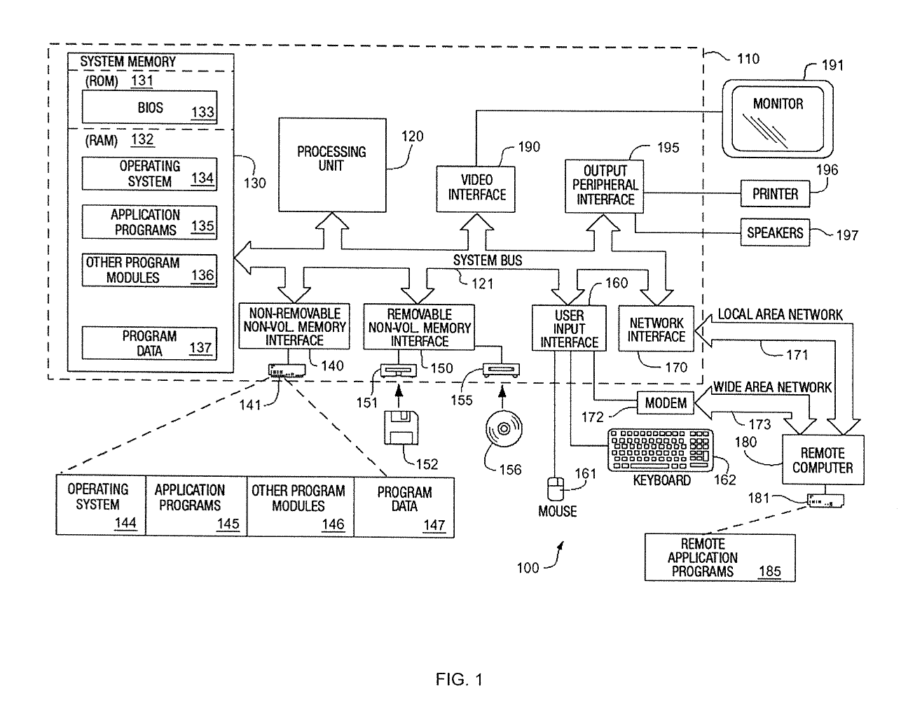

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140. Magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

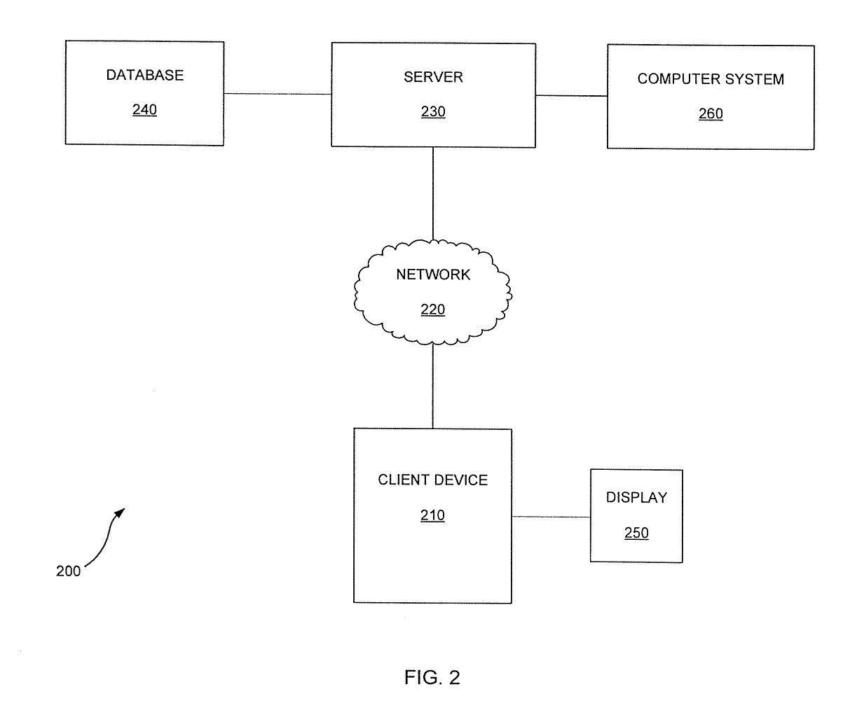

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the computer 110 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

An embodiment of the present invention includes an application that advantageously permits a user to assume a non-administrator status for tasks that do not require an administrative privilege, and manually or automatically escalate and/or demote only those tasks that require an enhanced or diminished security level, as the case may be, to be executed with an appropriate level of security.

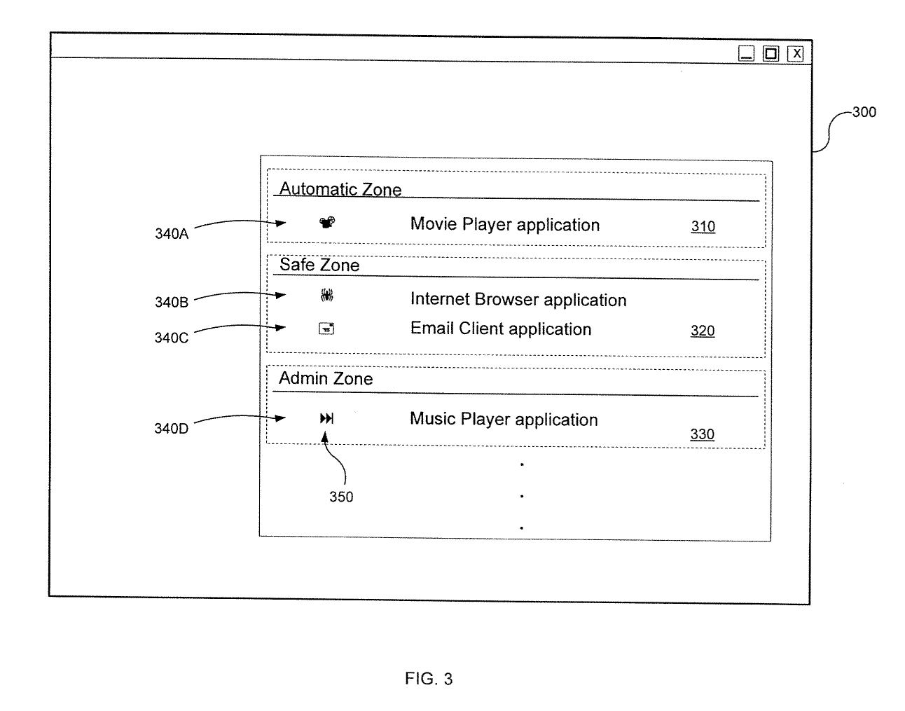

An embodiment of the present invention may also be configured to allow a user to create zones with which applications may be associated so as to make available respective sets of system resources to each application. Referring to FIG. 3, an embodiment of the invention may provide a user interface that includes a pane 300 displayable on a display device, such as the display 250. In the illustrated example, a plurality of security-level zones 310, 320 and 330 (as delineated by associated dashed lines) are presented in corresponding regions of the pane 300. Each zone 310, 320 and 330 represents a respective security context providing access to corresponding sets of system resources. For example, in an exemplary operating system, each of the zones 310, 320 and 330 may correspond to a Win32 Job Object. An embodiment of the invention may subsequently apply selected characteristics (such as, for example, ACLs and privileges) to each Job Object based on its respective zone configuration.

Still referring to FIG. 3, exemplary zone 330 represents an “Admin” zone. The Admin zone 330, in turn, represents a security context in which full administrator-level system resources are accorded to one or more applications associated with (i.e., running in) the Admin zone. Exemplary zone 320 represents a “Safe” zone. The Safe zone 320, in turn, represents a security context in which fewer than full administrator-level system resources are accorded to one or more applications associated with the Safe zone.

Exemplary zone 310 represents an “Automatic” zone. The Automatic zone 310, in turn, represents a security context in which a user-designated level of system resources are accorded to one or more applications associated with the Automatic zone and that have not otherwise been placed by the user in a designated zone. In an embodiment, the Automatic-zone 310 settings allow a user to mirror the settings of another zone at any selected point in time by selecting which of the available zones (e.g., Admin zone or Safe zone) will be so mirrored. Thus, if the Safe zone 320 is selected, all applications not otherwise placed into a zone will operate as if in the Safe zone. Alternatively, if the Admin zone 310 is selected, all applications not otherwise placed into a zone will operate as if in the Admin zone. In an embodiment, options for implementing this feature may be user-selectable. For example, the user may instruct an embodiment to create a separate Job Object for the Automatic zone 310 and change the attributes of the Job Object when the designation of a mirrored zone is changed. Alternatively, the user may instruct an embodiment to relocate applications from the Automatic zone 310 to the designated mirrored zone.

Upon establishment of the zones 310, 320 and 330, the user may choose one or more software applications 340A-340D to associate with and run subject to the security contexts of particular zones. By associating an application 340 with a particular zone, the user thus limits access by that application to the set of system resources corresponding to the chosen zone. In an embodiment, the user may move an application from a first zone or other location, such as, for example, a menu of available applications (not shown), to a second zone, thereby associating the application with the second zone, by “dragging and dropping” an icon 350 or other graphical representation of the application to the second zone using, for example, a conventional pointer device (not shown).

While the example illustrated in FIG. 3 includes only three zones, it should be understood that more or fewer than the three zones illustrated may be created and/or implemented in embodiments of the invention. Additionally, an embodiment of the invention enables the user to create each of the zones with which to associate applications. In doing so, the user may define the security context of, and system-resource availability associated with, each such created zone. Alternatively, one or more of the zones and associated security-context definitions may be included as part of a software application provided to the user.

An embodiment of the invention may implement the features described herein by creating and/or retrieving access tokens to be associated with applications in order to control the availability of system resources to such applications. For example, the movement of an application from one zone to another may be effected by the exchange of one token associated with the application for another. The creation and functionality of tokens implementable in an embodiment of the invention are discussed in commonly owned U.S. patent application Ser. No. ______ (Atty. Docket No. SFON-1-1007) entitled “CONTROL OF APPLICATION ACCESS TO SYSTEM RESOURCES,” which is herein incorporated by reference in its entirety.

An embodiment of the present invention, with respect to a selected zone, permits the user to select which user account the user will operate under. For example, User A may be signed in to a user account otherwise having full administrator privileges, but nonetheless utilize an application in, and subject to the restrictions associated with, a privileges-restricted zone, such as the Safe zone 320 discussed above. This may be achieved in an embodiment by creating a limited token that accurately identifies such user as User A, but not as an administrator. An embodiment of the present invention, with respect to a selected application, permits a user to switch from a first user account having a first set of privileges to a second user account having a second set of privileges without requiring a re-launch of the application. For example, an application running in association with User A may be temporarily switched to run as User B so that the application may perform operations that only User B is entitled to perform, such as, for example, installing other applications, drivers, downloading content, etc. Additionally, an embodiment of the present invention may be configured to permit a user to specify which user privileges (including, for example, shutdown, change-system-time, backup, etc.) may be restricted in one or more selected zones, or alternatively, which privileges are allowed in the one or more selected zones.

An embodiment of the present invention may be configured to enable a user to specify a processing priority for the one or more selected zones. An embodiment may further be configured to enable a user to specify a memory allocation for applications within the one or more specified zones.

Additionally, an embodiment of the present invention may be initiated automatically by an operating system each time a user logs into the operating system. A visual indication that an embodiment is running may be presented to a user as, for example, a tray bar (not shown) that contains a dropdown list of the current default zone setting. Alternatively, an embodiment may be initiated as part of the operating-system startup.

Additionally, in an embodiment of the invention an application associated with a limited token may be blocked from modifying or otherwise accessing any administrative data, but it can still read and modify any -user-data, such as, for example, MyDocuments or the user part of the registry. Accordingly, an embodiment offers a “lockdown” option whereby a user can specify that applications in the Safe zone 320 cannot WRITE at all. This means such applications can still “see” the user's registry and documents (which is required for useful operation) but cannot modify them. Such an embodiment may be implemented by marking the token with a new flag that indicates “This token is WRITE-RESTRICTED” when a user elects this option. As such, the token may be configured in such a way that it cannot write to any data, whether such data is administrative or personal.

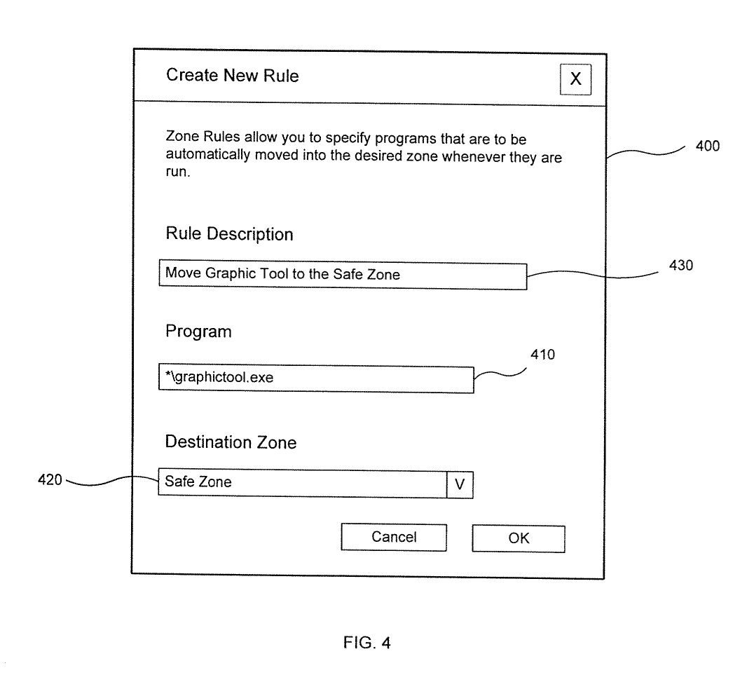

An embodiment of the present invention may also be configured to permit the selective application of predetermined rules in the one or more selected zones and/or to selected programs. Referring to FIG. 4, an embodiment provides a user interface that includes a pane 400 displayable on a display device, such as the display 250, that enables a user to designate selected applications to be automatically moved into a particular zone at the time such applications are run. In a data entry field 410, the user may identify the application to be automatically moved into a zone. In a data entry field 420, the user may identify the zone into which the application is to be automatically moved. In a data entry field 430, the user may create a name for the rule, thereby better enabling the user to later recognize the functionality of the rule. The selected applications are designated using either an exact match on their name (e.g., “c:\program files\internet applications\iexplore.exe”) or by defining a pattern (e.g., “*\iexplore.exe”) that the application name must adhere to in order to be selected. This mechanism includes, but is not limited to, applying the exact match or pattern match on the name of the application as well as other identifying characteristics of the application.

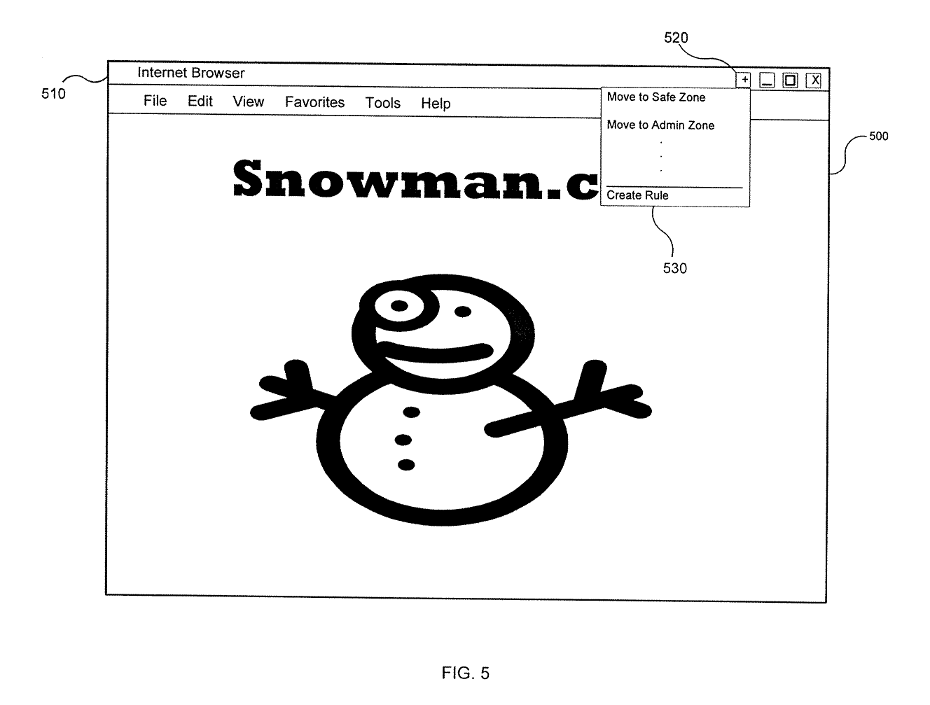

An embodiment of the present invention may also be configured to modify a portion of the user interface of each application to enable the convenient allocation of each such application to a particular zone. Referring to FIG. 5, an application, such as the illustrated Internet browser, includes a pane 500 displayable on a display device, such as the display 250. As is the case with many applications known in the art, the pane 500 associated with the Internet browser includes a titlebar 510. An embodiment of the invention provides a user-selectable button 520 in the titlebar 510 that, when selected by the user, invokes a menu 530 of options selectable by the user. Such options may, for example, enable the user to associate the application with a zone different from the zone in which the application is currently run and/or enable the user to invoke a pane, such as the pane 400 illustrated in and described with reference to FIG. 4, or other interface that will allow the user to create a zone-association rule to be applied to the application. Although the button 520 is, in the illustrated example, positioned in the titlebar 510, it should be appreciated that the button could be positioned in one or more different portions of the pane 500. Alternatively, the button 520 could be displayed in a portion of the display device external to the pane 500. Additionally, a user-selectable field other than the button 520 may be presented in order to enable the user to invoke the menu 530.

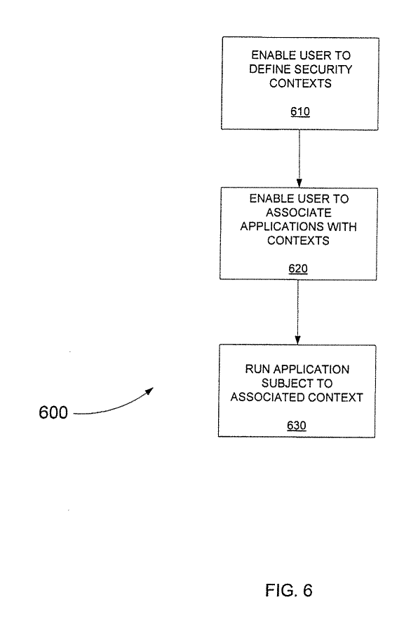

FIG. 6 illustrates a process 600, according to an embodiment of the invention, that can be implemented in a system having a security mechanism that determines access by an application to system resources based on a security context in which the application is run. This same system may employ the same or a different security mechanism, which determines access to system resources based on information in an access token against security information associated with each of the resources in order to control access of the application to the system resources. The process 600 is illustrated as a set of operations shown as discrete blocks. The process 600 may be implemented in any suitable hardware, software, firmware, or combination thereof. As such the process 600 may be implemented in computer-executable instructions that can be transferred from one computer, such as server 230, to a second computer, such as client device 210, via a communications medium, such as network 220. The order in which the operations are described is not to be necessarily construed as a limitation.

At a block 610, a user interface is provided that enables a user to define a plurality of security contexts. Alternatively, or additionally, definitions may be received, for example, by the client device 210 from the network 220 from the server 230. Each security context provides access to a respective set of the system resources. For example, an embodiment may provide a user interface (not shown) that enables a user to create and define the sets of system resources associated with the zones 310-330 described with reference to FIG. 3. In an embodiment, the user interface further enables the user to assign a processing priority to at least one of the security contexts. In an embodiment, the user interface further enables the user to assign a memory-usage allocation to at least one of the security contexts. In an embodiment, the user interface further enables the user to apply a set of predetermined rules to at least one of the security contexts and/or at least one of the applications. In an embodiment, the user interface further provides a representation of each security context in a respective portion of a display-device screen, such as the display of zone fields 310-330.

At a block 620, the user interface enables the user to associate each application of a plurality of applications with a respective one of the security contexts. For example, the applications may be associated with the Safe zone 320 or Admin zone 330 described herein with reference to FIG. 3. In an embodiment, the user interface enables the user to associate an application with a security context by placing a graphical representation of the application, such as the icon 350, in a screen portion associated with the security context, such as one of the zones 310-330. In an embodiment, the user interface enables the user to change the security context of an application by dragging the graphical representation of the application from a screen portion associated with a first security context and dropping the graphical representation in a screen portion associated with a second security context.

At a block 630, a first one of the applications is run subject to a first associated security context. For example, the applications may be run in, and subject to the system-resource limitations of, the Safe zone 320 or Admin zone 330. In an embodiment, the first one of the applications can transition, without re-launching the application, from running subject to the first security context to running subject to a second security context.

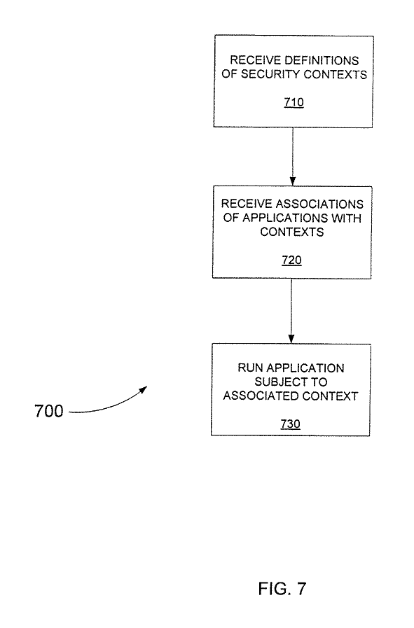

FIG. 7 illustrates a process 700, according to an embodiment of the invention, that can be implemented in a system having a security mechanism that determines access by an application to system resources based on a security context in which the application is run. This same system may employ the same or a different security mechanism, which determines access to system resources based on information in an access token against security information associated with each of the resources in order to control access of the application to the system resources. The process 700 is illustrated as a set of operations shown as discrete blocks. The process 700 may be implemented in any suitable hardware, software, firmware, or combination thereof. As such the process 700 may be implemented in computer-executable instructions that can be transferred from one computer, such as server 230, to a second computer, such as client device 210, via a communications medium, such as network 220. The order in which the operations are described is not to be necessarily construed as a limitation.

At a block 710, definitions of a plurality of security contexts are received. Each security context provides access to a respective set of the system resources. These definitions may be received, for example, by the client device 210 from a user of the client device or over the network 220 from the server 230.

At a block 720, receiving from the user an association of each application of a plurality of applications with a respective one of the security contexts. For example, the applications may be associated with the Safe zone 320 or Admin zone 330 described herein with reference to FIG. 3. In an embodiment, the user may associate an application with a security context by placing a graphical representation of the application, such as the icon 350, in a screen portion associated with the security context, such as one of the zones 310-330. In an embodiment, the user may change the security context of an application by dragging the graphical representation of the application from a screen portion associated with a first security context and dropping the graphical representation in a screen portion associated with a second security context.

At a block 730, a first one of the applications is run subject to a first associated security context. For example, the applications may be run in, and subject to the system-resource limitations of, the Safe zone 320 or Admin zone 330. In an embodiment, the first one of the applications can transition, without re-launching the application, from running subject to the first context to running subject to a second security context.

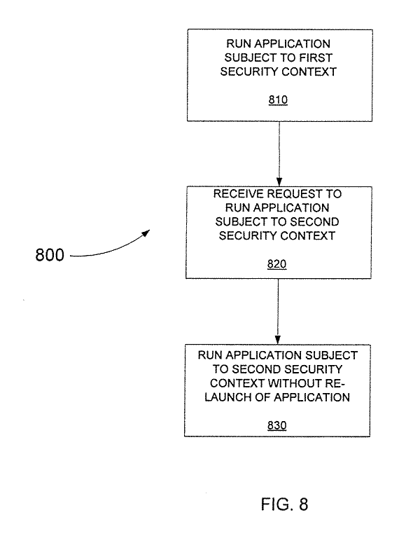

FIG. 8 illustrates a process 800, according to an embodiment of the invention, that can be implemented in a system having a security mechanism that determines access by an application to system resources based on a security context in which the application is run. This same system may employ the same or a different security mechanism, which determines access to system resources based on information in an access token against security information associated with each of the resources in order to control access of the application to the system resources. The process 800 is illustrated as a set of operations shown as discrete blocks. The process 800 may be implemented in any suitable hardware, software, firmware, or combination thereof. As such the process 800 may be implemented in computer-executable instructions that can be transferred from one computer, such as server 230, to a second computer, such as client device 210, via a communications medium, such as network 220. The order in which the operations are described is not to be necessarily construed as a limitation.

At a block 810, the application is run subject to a first security context providing access to a first set of the system resources. For example, the application may be run in the Admin zone 330 described herein with reference to FIG. 3.

At a block 820, a request is received to run the first application subject to a second security context providing access to a second set of the system resources different from the first set. For example, as discussed above with reference to FIG. 3, the application may be moved or otherwise reassigned from the Admin zone 330 to the Safe zone 320. In an embodiment, and as described herein with reference to FIG. 5, a user may provide the request via a user-selectable field displayed within a user interface associated with the first application.

At a block 830, the first application is run subject to the second security context. In an embodiment, the application runs subject to the second security context without re-launching the application. As such, for example, the application can transition “on the fly” from running in the Admin zone 330 to running in the Safe zone 320. In an embodiment, the first security context, with respect to the second security context, provides access to fewer of the system resources. Alternatively, the first security context, with respect to the second security context, provides access to at least the same system resources. In an embodiment, at least one of the security contexts is defined by at least one privilege and/or group identifier.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of transferring a computer program product from at least one first computer to at least one second computer connected to the at least one first computer through a communication medium, the method comprising the steps of:
(a) accessing, on the at least one first computer, computer-executable instructions that, when executed in a system having a security mechanism that determines access by an application to system resources based on a security context in which the application is run, perform at least the steps of:
(1) running a first application subject to a first security context providing access to a first set of the system resources;
(2) receiving a request to run the first application subject to a second security context providing access to a second set of the system resources different from the first set; and
(2) running the first application subject to the second security context, wherein the application runs subject to the second security context without re-launching the application; and
(b) transferring the computer-executable instructions from the at least one first computer to the at least one second computer through the communications medium.

2. The method of claim 1 wherein the first security context, with respect to the second security context, provides access to fewer of the system resources.

3. The method of claim 1 wherein the second security context, with respect to the first security context, provides access to at least the same system resources.

4. The method of claim 1 wherein at least one of the security contexts is defined by at least one privilege.

5. The method of claim 1 wherein at least one of the security contexts is defined by at least one group identifier.

6. The method of claim 1 wherein:
the first application includes a user interface; and
the computer-executable instructions further perform the step of displaying within the user interface a user-selectable field operable to enable the user to provide the request to run the first application subject to the second security context.

7. A computer-readable medium having computer-executable instructions that, when executed in a system having a security mechanism that determines access by an application to system resources based on a security context in which the application is run, perform at least the steps of:
(a) providing a user interface that:
(1) enables a user to define a plurality of security contexts, each security context providing access to a respective set of the system resources; and
(2) enables the user to associate each application of a plurality of applications with a respective one of the security contexts; and
(b) running a first one of the applications subject to a first associated security context.

8. The medium of claim 7 wherein the user interface further enables the user to define each set of the system resources.

9. The medium of claim 7 wherein the computer-executable instructions further perform the step of running the first one of the applications subject to a second security context without re-launching the application.

10. The medium of claim 7 wherein the user interface further enables the user to assign a processing priority to at least one of the security contexts.

11. The medium of claim 7 wherein the user interface further enables the user to assign a memory allocation to at least one of the security contexts.

12. The medium of claim 7 wherein the user interface further enables the user to apply a set of predetermined rules to at least one of the security contexts.

13. The medium of claim 7 wherein the user interface further enables the user to apply a set of predetermined rules to at least one of the applications.

14. The medium of claim 7 wherein the user interface further provides a representation of each security context in a respective portion of a display-device screen.

15. The medium of claim 14 wherein the user interface further enables the user to associate an application with a security context by placing a graphical representation of the application in a screen portion associated with the security context.

16. The medium of claim 15 wherein the user interface further enables the user to change the security context of an application by dragging a graphical representation of the application from a screen portion associated with a first security context and dropping the graphical representation in a screen portion associated with a second security context.

17. A computer-readable medium having computer-executable instructions that, when executed in a system having a security mechanism that determines access by an application to system resources based on a security context in which the application is run, perform at least the steps of:
receiving definitions of a plurality of security contexts, each security context providing access to a respective set of the system resources;
receiving from the user an association of each application of a plurality of applications with a respective one of the security contexts; and
running a first one of the applications subject to a first associated security context.

18. The medium of claim 17 wherein the computer-executable instructions further perform the step of running the first one of the applications subject to a second security context without re-launching the application.

19. The medium of claim 17 wherein the computer-executable instructions further perform the step of enabling the user to apply a set of predetermined rules to at least one of the security contexts.

20. The medium of claim 17 wherein the computer-executable instructions further perform the step of enabling the user to apply a set of predetermined rules to at least one of the applications.
